(19) United States
(12) Patent Application Publication
(10) Pub. No.: US 2010/0160445 A1
(43) Pub. Date: Jun. 24, 2010

(54) Synergistic Mixtures of OPP and DGH

(76) Inventors: Paul E. Carlson, Pittsburgh, PA (US); H. Edwin Nehus, Pittsburgh, PA (US); Jodi L. Martin, Imperial, PA (US)

Correspondence Address: Beck & Thomas, P.C.;SUITE 100, 1575 McFARLAND ROAD, PITTSBURGH, PA, 15216-1808, US

(21) Appl. No.: 11/780,224

(22) Filed: Jul. 19, 2007

Related U.S. Application Data
(63) Continuation-in-part of application No. 10/345,797, filed on Jan. 16, 2003, now Pat. No. 7,262,222.
(60) Provisional application No. 60/349,636, filed on Jan. 17, 2002.

(51) Int. Cl. A01N 47/44; A01P 1/00

(52) U.S. Cl. 514/634

(57) ABSTRACT

Ortho phenylphenol or its sodium salt is shown to form synergistic antimicrobial mixtures with nitrogen and aldehyde-containing microbiocides.

### CROSS REFERENCE TO RELATED APPLICATION

This application is a continuation-in-part of U.S. application Ser. No. 10/345,797, filed Jan. 16, 2003, which claims the benefit of U.S. Provisional Application No. 60/349,636 filed Jan. 17, 2002. Application Ser. Nos. 10/345,797 and 60/349,636 are incorporated by reference

### BACKGROUND OF THE INVENTION

(1) Field of the Invention

This invention relates to synergistic mixtures of o-phenylphenol and/or its sodium salt with dodecylguanidine hydrochloride and/or nitrogen-containing microbiocides (antimicrobials) and the use of the synergistic combinations in industrial applications.

(2) Description of Related Art

O-phenylphenol and Sodium orthophenylphenate (separately or collectively sometimes herein known as “OPP”, orthophenolphenol or o-phenylphenol and/or its sodium salt) are known and used extensively as antimicrobial agents in various industrial applications such as preservation of various materials including paints and adhesives as well as to control unwanted microorganisms found in various process waters such as cooling water, paper mills and petroleum production process waters.

The contamination of various products with microbiological growth has led to the study and application of large classes of preservatives, antimicrobial compositions, and microbiocides to inhibit or prevent such contamination. Industrial process waters also have been studied and treated extensively. Preservatives are used in a broad range of products including but not limited to adhesives, cosmetics and toiletries, disinfectants and sanitizers, leather, metalworking fluids, paints and coatings, plastics and resins, latex polymers, textiles and wood. Failure to preserve these products adequately will result in spoilage and loss of the materials to be preserved and will result in an economic loss. Similarly, microbiological growths can have dire consequences if process waters are not adequately treated. Process waters include but are not limited to: Industrial Recirculating Water, Paper Products—Paper, Petroleum Production and Leather Tanning. Process waters are of concern because when fouled with biofilms/slime that develop from the indigenous microbes present, biofilms/slime may develop into thick gelatinous like masses. Slime/biofilm is produced by a wide range of bacteria, fungi, and yeast. Slime/biofilm will interfere with the process resulting in a loss of heat transfer, corrosion and fouling.

Some of the microorganisms responsible for the extensive economic effects described above have exhibited resilient resistant tendencies against the standard and widely used microbiocides and antimicrobial compositions, and accordingly the search for more effective antimicrobials has extended to a search for synergistic combinations of materials considered to be relatively safe for humans. There remains a need for combinations of materials of low or nonexistent toxicity to humans which are effective against a wide range of microorganisms.

### BRIEF SUMMARY OF THE INVENTION

This invention includes synergistic ratios of aqueous blends of orthophenylphenol or Sodium orthophenylphenate with the following chemical classes: nitrogen-containing antimicrobial compounds and aldehyde-containing antimicrobial compounds. Generally, any ratio of OPP to the other antimicrobial within the range of 1%-99% to 99%-1% by weight will be effective to some degree, but we prefer to use the most efficient combinations. We have found that mixtures of O-phenylphenol with aldehydes and nitrogen-containing antimicrobials can demonstrate synergistic effects as compared to either of the two ingredients used separately against mixed cultures of gram positive and gram negative organisms.

Nitrogen-containing compounds include but are not limited to the following:
1-(3-chloroallyl)-3,5,7-triaza-1-amoniaadamantane, Dodecylguanadine acetate, Dodecylguanadine HCl, n-Alkyldimethlbenzyl ammonium chloride, Dialkyl dimethyl ammonium chloride.

Aldehyde compounds include but are not limited to glutaraldehyde.

### DETAILED DESCRIPTION OF THE INVENTION

Orthophenylphenol was tested in combination with known antimicrobial nitrogen-containing compounds and aldehydes. The synergistic blends was determined using a dose protocol. The combinations were evaluated in synthetic white water with pH values of 5.5 and 8.0. The materials were tested against an artificial bacterial consortium containing approximately equal numbers of six bacterial strains. Although the test strains are representative of organisms present in paper mill systems, the effect is not limited to these bacteria. Two of the strains were Klebsiella pneumonia (ATCC 13883) and Pseudomonas aeruginosa (ATCC 15442). The other four strains were isolated from papermill systems and have been identified as Curtobacterium flaccumfaciens, Burkhlderia cepacia, Bacillus maroccanus, and Pseudomonas glethei. Each strain was inoculated at 37° C. overnight, then suspended in sterile saline. Equal volumes of each strain were then combined to prepare the consortium. The bacterial consortium was distributed into the wells of a microtiter plate in the presence or absence of various concentrations of the active materials. The microtiter plates were incubated at 37° C. Optical density (O.D.) readings at 650 nm were taken initially (t₀) and after time 4 hours (t₄) of incubation.

The raw data was converted to “bacterial growth inhibition percentages” according to the following formula:

% Inhibition=[(a−b)÷a]·100

where:
a=(O.D. of control at tₙ)−(O.D. of control at t₀)
b=(O.D. of treatment at tₙ)−(O.D. of treatment at tₒ)
The inhibition values can be plotted versus dosage for each active and the particular blend.
This results in a dose response curve from which the dosage to yield 50% inhibition (I₅₀) can be calculated. In the examples (tables) below, the I₅₀ values are expressed as parts per million (ppm) of active material.

The synergism index (SI) was calculated by the equations described by F. C. Kull, P. C. Eisman, H. D. Sylwestrowicz, and R. L. Mayer (1961), Applied Microbiology 9, 538-541. The values are based on the amount needed to achieve a specified end point. The end point selected for these studies was 50% inhibition of bacterial growth.

Synergy Index (SI)=(QA÷Qa)+(QB÷Qb)

where:
QA=quantity of compound A in mixture, producing the end point
Qa=quantity of compound A₁ acting alone, producing the end point
QB=quantity of compound B in mixture, producing the end point
Qb=quantity of compound B₁ acting alone, producing the end point

If SI is less than 1, synergism exists; if SI is greater than 1, antagonism exists, if SI is equal to 1, an additive effect exists.

Nitrogen compounds form synergistic blends with OPP. To test the hypothesis the following examples of the class were tested:
Dodecylguanadine HCl, Di alkyl dimethyl ammonium chloride and 1-(3-chloroallyl)-3,5,7-triaazo-1-amoniaadamantane. As is known in the art, the N-alkyl dimethyl benzyl ammonium chloride is commonly a mixture of quaternary ammonium compounds wherein the alkyl group may comprise an alkyl group of 10 to 20 carbon atoms. The synergistic activity can be found in examples 1 through 3.

### Example 1

The example shows synergistic activity between OPP and Dodecylguanidine Hydrochloride when fed simultaneously in a bacterial consortium in synthetic water at pH 5.0 and 8.0.

DGH* & NaOPP @ pH 5.5

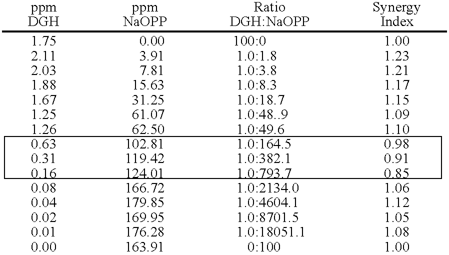

DGH* & NaOPP @ pH 8.0

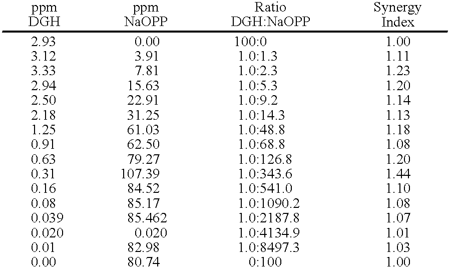

*DGH—Dodecylguanidine Hydrochloride

### Example 2

The example shows synergistic activity between OPP and ADBAC when fed simultaneously in a bacterial consortium in synthetic water at pH 5.0 and 8.0.

ADBAC* & NaOPP @ pH 5.5

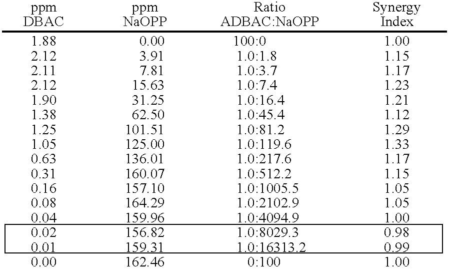

ADBAC* & NaOPP @ pH 8.0

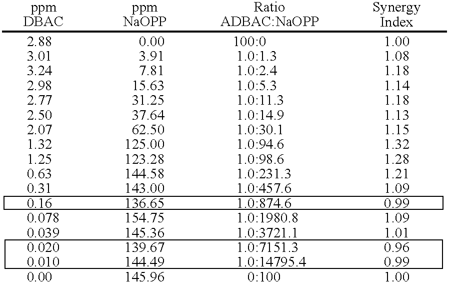

*ADBAC—N-Alkyl (60% C14, 30% C16, 5% C12, 5% C18) dimethyl benzyl ammonium chloride

### Example 3

The example shows synergistic activity between OPP and CTAC when fed simultaneously in a bacterial consortium in synthetic water at pH 5.0 and 8.0.

CTAC* & NaOPP @ pH 5.5

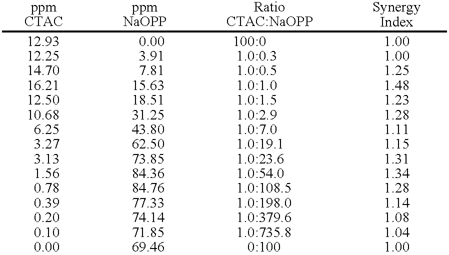

CTAC* & NaOPP @ pH 8.0

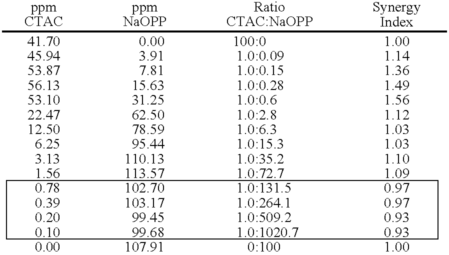

*CTAC—cis-1-(3-Chloroallyl)-3,5,7-triaza-1-azoniaadamantane chloride

Aldehyde compounds form synergistic blends with OPP. Results with glutaraldehyde are shown in Example 4.

### Example 4

The example shows synergistic activity between OPP and Glutaraldehyde when fed simultaneously in a bacterial consortium in synthetic water at pH 5.0 and 8.0.

GLUT* & NaOPP @ pH 5.5

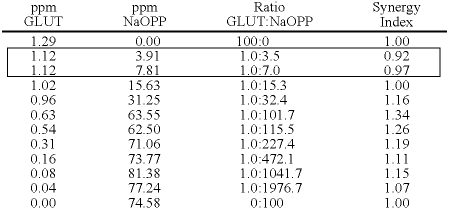

GLUT* & NaOPP @ pH 8.0

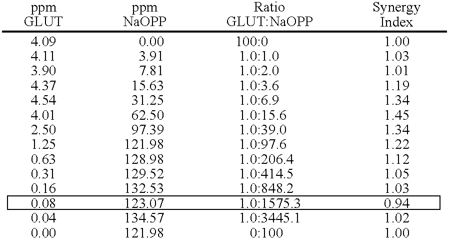

*GLUT—Glutaraldehyde

The following was an additional procedure for determining synergism of OPP and DGH.

### Synergism

Synergism was demonstrated by adding DGH and OPP in varying ratios by weight, and over a wide range of concentrations to nutrient broth at pH 7.0, 8.0 and 9.0 in multiwell sterile plastic plates. Stock solutions of each product were prepared in sterile distilled water. Synergism was measured by the method first described by F. C. Kull, P. C. Eisman, H. D. Sylwestrowicz and R. L. Mayer in Applied Microbiology, 9, 538-41 (1946). This manner of determining synergism has been widely used and is industrially acceptable. It is believed that the specified method is sufficient in explaining the process. However for a further description, reference can be made to U.S. Pat. No. 3,231,509 and its file history, where this type of data was considered acceptable. In this study synergy was clearly demonstrated with the combination of DGH/OPP in the nutrient broth at pH 7.0, 8.0 and 9.0.

### Safety

Aseptic technique was practiced at all times when handling samples which are potentially contaminated. Protective clothing was worn in the microbiology laboratory, including gloves, safety glasses and laboratory coats.

### Equipment

1. Incubator capable of maintaining a variable temperature range (25-45 C)
2. Samples of each biocide or test compound to be examined
3. Microtiter plates—96 well with lid, sterile.
4. 8-12 channel micropipetting device capable of pipetting 0-250 ul volumes
5. Micropipette tips capable of holding up to 250 ul volumes
6. Sterile microbiological culture broth. Trypticase Soy Broth (TSB) or Nutrient Broth (NB) is recommended for bacteria and Sabouraud Maltose Broth (SMB) or Sabouraud Dextrose Broth (SDB) is recommended for yeasts and molds. In the case of this particular study the microbiological culture medium was Nutrient Broth at pH 7.0, 8.0 and 9.0.
7. Pure cultures of microorganisms of choice grown on appropriate agar medium
8. Sterile distilled water
9. 100 mL volumetric flasks (one for each biocide to be tested)
10. Sterile 10 mL tubes of Phosphate buffer (Butterfield's buffer pH 7.2+/−0.2). Contains purified water, monobasic potassium phosphate and sodium hydroxide for pH adjustment.
11. Sterile cotton swabs
12. 0.5 MacFarland Turbidity Standard

### Reagents

Preparation of Bacterial Inocula:

The day before testing, perform a streak plate of each organism to be tested on an appropriate agar medium (Trypticase Soy Agar). Organisms tested in this study were: Wild strain bacteria isolated from previously contaminated industrial systems and which were identified as: Pseudomonas sp., Escherchia coli , Enterobacter sp., Alcaligenes sp. and Alcaligenes faecalis. On the day of the test, use a sterile cotton swab to harvest some of the growth. Place swab into a tube containing 10 mL sterile phosphate buffer. Compare and adjust the turbidity of the organisms in the tube to 1×108 cfu/mL using a 0.5 MacFarland Turbidity Standard. Dilute the 10 mL tube into 90 mL of sterile 2× nutrient broth at pH 7.0, 8.0 and 9.0.

### Procedure

1. Design the layout of the microtiter plates based on the number of organisms to test and the number of biocides and desired concentrations to test. A separate microtiter plate is required for testing each biocide alone, in addition to the combination microtiter plate.
2. Prepare a working stock solution of each biocide to be tested. For the combination microtiter plate, the working stock solution of Biocide A will be 8× the concentration desired in the first well of the combination microtiter plate. The working stock solution of Biocide B will be 4× the concentration desired in the first well of the combination microtiter plate. For the alone microtiter plates, the working stock solutions of Biocide A and Biocide B will both be 4× the concentration desired in the first well of the single biocide microtiter plates.

### Biocide A

Dodecylguanidine hydrochloride: (For combination plates) A solution of this product which is 35% active, was made as follows: 8×8000=8000 ppm active=8000/0.35=22,857 ppm, 2.28 g into 100 mL sterile diH2O. Levels to test are: 1000 ppm, 500 ppm, 250 ppm, 125 ppm, 62.5 ppm, 31.2 ppm, 15.6 ppm, 7.8 ppm, 3.9 ppm, 1.95 ppm

(For alone plates) A solution was made as follows: 4×1000=4000 ppm active=4000/0.35=11,428 pm, 1.14 g into 100 mL sterile diH2O. Levels to test are: 1000 ppm, 500 ppm, 250 ppm, 125 ppm, 62.5 ppm, 31.2 ppm, 15.6 ppm, 7.8 ppm, 3.9 ppm, 1.95 ppm.

### Biocide B

Ortho-PhenylPhenol: (For combination plates) Make a solution of this product which is 99% active, 4×125=500 ppm active=500/0.99=505 ppm, 0.05 g into 100 mL MeOH and sterile diH2O. Level to test is 125 ppm.

(For alone plates) A solution was made as follows: 4×1000=4000 ppm active=4000/0.99=4040 ppm, 0.4 into 100 mL MeOH and sterile diH2O. Levels to test are: 1000 ppm, 500 ppm, 250 ppm, 125 ppm, 62.5 ppm, 31.2 ppm, 15.6 ppm, 7.8 ppm, 3.9 ppm, 1.95 ppm

3. Place 50 ul of sterile distilled water in all of the rows in columns 1 through 10, and 100 ul of sterile distilled water in all of the rows in columns 11 and 12 of the 96 well combination microtiter plate. Place 100 ul of sterile distilled water in each well of the 96 well alone microtiter plates.
4. For the combination microtiter plate, place 50 ul of the Biocide A stock solution into all of the rows in column 1 of the combination microtiter plate.
5. Serially dilute Biocide A twofold across the microtiter plate through column 10. Mix each well by pipetting up and down as you are performing the dilution scheme.
6. Place 50 ul of the Biocide B stock solution into all the rows in columns 1 through 10 of the combination microtiter plate.
7. For the single biocide microtiter plates, place 100 ul of Biocide A (4× working stock solution) into all rows in the column. Serially dilute Biocide A two fold across the microtiter plate through column 10. Mix each well by pipetting up and down as you are performing the dilution scheme.
8. Repeat Step 7 for the Biocide B microtiter plate.
9. The 11th column in all plates serves as a broth control. Add 100 ul of 2× nutrient broth at either pH 7.0, 8.0 or 9.0 into each well in this column.
10. The 12th column serves as an organism control.
11. Add 100 ul of the inoculum to the appropriate rows of the microtiter plate in columns 1 through 10 and 12 as listed below.

### Bacterial Plates

Row A through H: Mixed Inoculum at a strength of 1×10E6 cfu/ml

Incubate the microtiter plate at the desired temperature for the desired amount of time. This plate represents the biostatic activity of the test compound(s). Bacterial plates are usually incubated at 35-37 C for 24 hours.

### Quality Control

The organism control (12th column) and the nutrient broth control (11th column) wells serve as controls for this experiment. If no growth appears in the organism control or if growth appears in the broth control, the test is invalid and must be repeated.

Layout of Combination Biocide Plate each level was replicated 8 times

Biocide A (8X) DGH Biocide B (4X) OPP

| | Stock Sol | Stock Sol. | |
|---|---|---|---|
| Well# | 8000 ppm | 500 ppm | Ratio A:B |
| 1 | 1000 | 125 | 8:1 |
| 2 | 500 | 125 | 4:1 |
| 3 | 250 | 125 | 2:1 |
| 4 | 125 | 125 | 1:1 |
| 5 | 62.5 | 125 | 1:2 |
| 6 | 31.25 | 125 | 1:4 |
| 7 | 15.6 | 125 | 1:8 |
| 8 | 7.8 | 125 | 1:16 |
| 9 | 3.9 | 125 | 1:30 |
| 10 | 1.95 | 125 | 1:65 |
| 11 | nutrient broth | nutrient broth | |
| 12 | organism control | organism control | |

Layout of Alone Biocide Plate the levels were replicated 8 times:

| Well # | |
|---|---|
| | Biocide A (4X) DGH |
| | Stock Sol. (4000 ppm) |
| 1 | 1000 |
| 2 | 500 |
| 3 | 250 |
| 4 | 125 |
| 5 | 62.5 |
| 6 | 31.25 |
| 7 | 15.6 |
| 8 | 7.8 |
| 9 | 3.9 |
| 10 | 1.95 |
| 11 | nutrient broth |
| 12 | organism control |
| | Biocide B (4X) OPP |
| | Stock Sol. (4000 ppm) |
| 1 | 1000 |
| 2 | 500 |
| 3 | 250 |
| 4 | 125 |
| 5 | 62.5 |
| 6 | 31.25 |
| 7 | 15.6 |
| 8 | 7.8 |
| 9 | 3.9 |
| 10 | 1.95 |
| 11 | nutrient broth |
| 12 | organism control |

### Interpretation

Minimum Inhibitory Concentration (MIC)—the lowest concentration of test compound that results in no evidence of growth at the end of the incubation period.

Determine the K value for each combination biocide the MIC level:

K=concentration of Biocide A in combination/Concentration of Biocide A alone+concentration of Biocide B in combination/concentration of Biocide B alone

If K<1, the biocides are considered to be synergistic.
If K=1, the biocides are considered to be additive
If K>1, the biocides are considered to be antagonistic.

### Results of Bacterial Testing

### MIC Results for DGH Alone

1) DGH against a mixed inoculum of bacteria at pH 7.0=62.5 ppm
2) DGH against a mixed inoculum of bacteria at pH 8.0=15.6 ppm
3) DGH against a mixed inoculum of bacteria at pH 9.0=15.6 ppm

### MIC Results for OPP Alone

1) OPP against a mixed inoculum of bacteria at pH 7.0=>1000 ppm
2) OPP against a mixed inoculum of bacteria at pH 8.0=1000 ppm
3) OPP against a mixed inoculum of bacteria at pH 9.0=500 ppm

MIC RESULTS FOR DGH/OPP

| | | | |
|---|---|---|---|
| ppm | ppm | | Synergy |
| DGH | NaOPP | Ratio DGH:NaOPP | Index |

DGH* & NaOPP @ pH 7.0

| | | | |
|---|---|---|---|
| 62.5 | 0.00 | 100:0 | 1.00 |
| 1000 | 125 | 8:1 | 16.125 |
| 500 | 125 | 4:1 | 8.125 |
| 250 | 125 | 2:1 | 4.125 |
| 125 | 125 | 1:1 | 2.125 |
| 62.5 | 125 | 1:2 | 1.125 |
| 31.2 | 125 | 1:4 | .624 |

DGH* & NaOPP @ pH 8.0

| | | | |
|---|---|---|---|
| 15.6 | 0.00 | 100:0 | 1.00 |
| 1000 | 125 | 8:1 | 64.228 |
| 500 | 125 | 4:1 | 32.176 |
| 250 | 125 | 2:1 | 16.151 |
| 125 | 125 | 1:1 | 8.138 |
| 62.5 | 125 | 1:2 | 4.131 |
| 31.2 | 125 | 1:4 | 2.125 |
| 15.6 | 125 | 1:8 | 1.125 |
| 7.8 | 125 | 1:16 | 0.625 |
| 3.9 | 125 | 1:30 | 0.375 |
| 1.95 | 125 | 1:65 | 0.250 |
| 0.00 | 1000 | 0:100 | 1.00 |

DGH* & NaOPP @ pH 9.0

| | | | |
|---|---|---|---|
| 15.6 | 0.00 | 100:0 | 1.00 |
| 1000 | 125 | 8:1 | 64.352 |
| 500 | 125 | 4:1 | 32.301 |
| 250 | 125 | 2:1 | 16.276 |
| 125 | 125 | 1:1 | 8.262 |
| 62.5 | 125 | 1:2 | 4.256 |
| 31.2 | 125 | 1:4 | 2.250 |
| 16.5 | 125 | 1:8 | 1.250 |
| 7.8 | 125 | 1:16 | 0.750 |
| 3.9 | 125 | 1:30 | .500 |
| 1.95 | 125 | 1:65 | .375 |
| 0.00 | 500 | 0:100 | 1.00 |

*DGH—Dodecylguanidine Hydrochloride

DGH/OPP—Results against a mixed bacterial inoculum at pH 7.0=31.2 ppm DGH and 125 ppm OPP

DGH/OPP—Results against a mixed bacterial inoculum at pH 8.0=1.95 ppm DGH and 125 ppm OPP

DGH/OPP—MIC Results against a mixed bacterial inoculum at pH 9.0=1.95 ppm DGH and 125 ppm OPP

### Calculation of Synergy

### Nutrient Broth at pH 7.0

DGH Alone MIC Value pH 7.0=62.5 ppm

OPP Alone MIC Value pH 7.0=>1000 ppm

DGH/OPP MIC Value pH 7.0=31.2 ppm DGH/125 ppm OPP

### Synergy Calculation for DGH and OPP pH 7.0

K=31.2/62.5+125/1000=0.6242

Effective Ratio of DGH to OPP is 1:4 at a pH of 7.0

### Nutrient Broth at pH 8.0

DGH Alone MIC Value pH 8.0=15.6 ppm

OPP Alone MIC Value pH 8.0=1000 ppm

DGH/OPP MIC Value pH 8.0=1.95 ppm DGH/125 ppm OPP

K=1.95/15.6+125/1000=0.25

Effective Ratio of DGH to OPP is 1:65 at a pH of 8.0

### Nutrient Broth at pH 9.0

DGH Alone MIC Value pH 9.0=15.6 ppm

OPP Alone MIC Value pH 9.0=500 ppm

DGH/OPP MIC Value pH 9.0=1.95 ppm DGH/125 ppm OPP

### Synergy Calculation for DGH and OPP pH 9.0

K=1.95/15.6+125/500=0.375

Effective Ratio of DGH to OPP is 1:65 at a pH of 9.0

Antimicrobial synergism between OPP and DGH can also be shown when it is placed in a coating and the antimicrobial resistance results of the coating containing OPP and DGH are better than the antimicrobial resistance results of OPP and DGH individually.

Biocidal agents are available to work both in the can or batch process and in the dried film. For this reason many manufacturers include a biocide agent in the formulation of the coatings so it can kill both bacteria and yeast which can be present.

The biocides used in the coatings market can be grouped into two classes.

In-can or batch preservatives—these are chemical compounds that are added to the coatings formulations during manufacturer to prevent biodegradation. Bacteria and yeast are often introduced to the coatings during manufacturing and can come from the raw materials used or from poor plant hygiene practices. There are a number of chemical active ingredients used for prevention of in-can microbial growth. Antimicrobials are usually added as early as possible in the production process to prevent in-can growth of undesirable organisms.

Dry film fungicides/mildewcides—these chemicals are used as performance additives in both aqueous and solvent-based systems to inhibit fungal and algae growth in the dry film to protect against premature coating failure. The growth of organisms, such as mold, mildew and algae is undesirable from an appearance point of view. These organisms also cause the physical breakdown of the coating film, which can lead to an increase in porosity of the surface of the film and subsequent loss of adhesion to the substrate. Moisture also may contribute to the growth of fungus, which can decay a wood substrate.

One type of coating is paint. The antimicrobial properties of the OPP and DGH combination was tested in three paint samples.

Preservation Testing was performed on the three paint samples: Acrylic Flat, Acrylic and Vinyl Acrylic. Each sample was treated with various levels OPP, DGH individually and a mixture of OPP and DGH. All samples were then inoculated with wild strain bacteria isolated from previously contaminated systems. Following the initial inoculation, the samples were reinoculated on day 7. This testing scenario best simulates what happens in a “real world” situation. Samples that passed the two inoculation challenge are adequately protected for long-term storage. Results of this study are recorded as follows:

| Sample Identification | Effective Preservative (ppm) | |
|---|---|---|
| Acrylic Flat | 150 | ppm OPP/DGH |
| | 1500 | ppm DGH |
| | >4000 | ppm OPP |
| Acrylic | 150 | ppm OPP/DGH |
| | 2000 | ppm DGH |
| | >4000 | ppm OPP |
| Vinyl Acrylic Flat | 500 | ppm OPP/DGH |
| | >2000 | ppm DGH |
| | 4000 | ppm P1 |

This demonstration shows the synergistic effect of the two active ingredients in the OPP/DGH combination. In each study, the combination of DGH and OPP were tested together and separately and in each case the combination of the two resulted in superior performance, with lower dosage ranges, proving the excellent synergy of the 3:1 ratio of DGH to OPP. Following the in-can preservation study the mildew resistance properties of various products were tested in each of the three paint samples.

TABLE 1
In-Can Preservation Test Acrylic
Paint Evaluations-Acrylic

| | Conc. | Conc. | Sample | 1st | | 2nd | |
|---|---|---|---|---|---|---|---|
| Product | (ppm) | (ul) | # | Inoculation | | Inoculation | |
| OPP/ | 150 | 4 ul | 15 | 3 | 0 | 2 | 0 |
| DGH | 250 | 6 ul | 16 | 3 | 0 | 2 | 0 |
| | 500 | 11 ul | 17 | 3 | 0 | 2 | 0 |
| | 750 | 18 ul | 18 | 3 | 0 | 2 | 0 |
| | 1000 | 22 ul | 19 | 3 | 0 | 2 | 0 |
| | 2000 | 45 ul | 20 | 3 | 0 | 2 | 0 |
| DGH | 250 | 6 ul | 37 | 3 | 3 | 3 | 3 |
| | 500 | 11 ul | 38 | 3 | 3 | 2 | 3 |
| | 750 | 15 ul | 39 | 3 | 2 | 2 | 2 |
| | 1000 | 22 ul | 40 | 3 | 2 | 1 | 1 |
| | 1500 | 34 ul | 41 | 3 | 0 | 1 | 0 |
| | 2000 | 45 ul | 42 | 3 | 0 | 1 | 0 |
| OPP | 1000 | 22 ul | 43 | 3 | 3 | 3 | 3 |
| | 1500 | 34 ul | 44 | 3 | 3 | 3 | 3 |
| | 2000 | 45 ul | 45 | 3 | 3 | 3 | 3 |
| | 2500 | 54 ul | 46 | 3 | 3 | 3 | 3 |
| | 3000 | 68 ul | 47 | 3 | 3 | 3 | 3 |
| | 3500 | 75 ul | 48 | 3 | 3 | 3 | 3 |
| | 4000 | 90 ul | 49 | 3 | 3 | 3 | 3 |

Legend
4 = Heavy Microbial Growth
3 = Moderate Microbial Growth
2 = Slight Microbial Growth
1 = Trace Microbial Growth
0 = No Microbial Growth

TABLE 2
Preservation Properties of a Paint Formulation
Test Method: In-Can Preservation Test Acrylic Flat
Paint Evaluations Vinyl Acrylic Flat

| | Conc. | Conc. | Sample | 1st | | 2nd | |
|---|---|---|---|---|---|---|---|
| Product | (ppm) | (ul) | # | Inoculation | | Inoculation | |
| OPP/ | 150 | 4 ul | 15 | 3 | 0 | 3 | 0 |
| DGH | 250 | 6 ul | 16 | 3 | 0 | 3 | 0 |
| | 500 | 11 ul | 17 | 3 | 0 | 3 | 0 |
| | 750 | 18 ul | 18 | 3 | 0 | 3 | 0 |
| | 1000 | 22 ul | 19 | 3 | 0 | 3 | 0 |
| | 2000 | 45 ul | 20 | 3 | 0 | 3 | 0 |
| DGH | 250 | 6 ul | 37 | 3 | 2 | 3 | 2 |
| | 500 | 11 ul | 38 | 3 | 2 | 2 | 2 |
| | 750 | 15 ul | 39 | 3 | 2 | 2 | 2 |
| | 1000 | 22 ul | 40 | 3 | 2 | 3 | 2 |
| | 1500 | 34 ul | 41 | 3 | 2 | 3 | 1 |
| | 2000 | 45 ul | 42 | 3 | 0 | 1 | 0 |
| OPP | 1000 | 22 ul | 43 | 3 | 3 | 3 | 3 |
| | 1500 | 34 ul | 44 | 3 | 3 | 3 | 3 |
| | 2000 | 45 ul | 45 | 3 | 3 | 3 | 3 |
| | 2500 | 54 ul | 46 | 3 | 3 | 3 | 3 |
| | 3000 | 68 ul | 47 | 3 | 3 | 3 | 3 |
| | 3500 | 75 ul | 48 | 3 | 3 | 3 | 3 |
| | 4000 | 90 ul | 49 | 3 | 3 | 3 | 3 |

Legend
4 = Heavy Microbial Growth
3 = Moderate Microbial Growth
2 = Slight Microbial Growth
1 = Trace Microbial Growth
0 = No Microbial Growth

TABLE 3
Preservation Properties of a Paint Formulation
Test Method: In-Can Preservation Test Vinyl Acrylic Flat
Paint Evaluations - Acrylic Flat

| | Conc. | Conc. | Sample | 1st | | 2nd | |
|---|---|---|---|---|---|---|---|
| Product | (ppm) | (ul) | # | Inoculation | | Inoculation | |
| OPP/ | 150 | 4 ul | 15 | 3 | 1 | 3 | 1 |
| DGH | 250 | 6 ul | 16 | 3 | 1 | 3 | 1 |
| | 500 | 11 ul | 17 | 2 | 0 | 3 | 0 |
| | 750 | 18 ul | 18 | 2 | 0 | 1 | 0 |
| | 1000 | 22 ul | 19 | 2 | 0 | 1 | 0 |
| | 2000 | 45 ul | 20 | 2 | 0 | 1 | 0 |
| DGH | 250 | 6 ul | 37 | 3 | 2 | 3 | 2 |
| | 500 | 11 ul | 38 | 2 | 2 | 3 | 1 |
| | 750 | 15 ul | 39 | 2 | 2 | 3 | 1 |
| | 1000 | 22 ul | 40 | 2 | 2 | 3 | 1 |
| | 1500 | 34 ul | 41 | 2 | 2 | 2 | 2 |
| | 2000 | 45 ul | 42 | 2 | 2 | 2 | 2 |
| OPP | 1000 | 22 ul | 43 | 2 | 2 | 2 | 2 |
| | 1500 | 34 ul | 44 | 2 | 2 | 2 | 2 |
| | 2000 | 45 ul | 45 | 2 | 2 | 2 | 2 |
| | 2500 | 54 ul | 46 | 2 | 2 | 2 | 2 |
| | 3000 | 68 ul | 47 | 2 | 2 | 2 | 2 |
| | 3500 | 75 ul | 48 | 2 | 1 | 2 | 1 |
| | 4000 | 90 ul | 49 | 2 | 0 | 2 | 0 |

Testing was also completed on Franklin International Caulking Adhesives. The results can be seen in the tables 4-6 below. The testing that was conducted was done in accordance with test ASTM D3273 as set forth in the Annual Book of ASTM Standards, Vol 06.01 which is hereby incorporated by reference. This is a standard test method for mildew known to those skilled in the art. When performing this test OPP was not tested by itself as it is known in the art of coatings that significant amounts of OPP are required, typically in the range of 2,000 to 10,000 ppm which is supported by EPA Registration No.'s 39967-11-67869 and EPA Registration No. 464-78-67869. An example of the significant amounts of OPP needed can also be seen in the OPP results in the paint testing shown above.

The results of the testing show that the combination of OPP and DGH was superior to the results of the DGH by itself and thus synergism occurred.

### Mildew Resistance Testing of Titebond Professional Tub Surround Adhesive

### Legend

10=No Mildew Growth, Excellent Mildew Resistance
7-9=Trace Mildew Growth, Very Good Mildew Resistance
6-5=Moderate Mildew Growth, Poor Mildew Resistance
4-0=Heavy Mildew Growth, Failed

TABLE 4
Test Method: ASTM D3273

| | | | | Mildew Results | | | |
|---|---|---|---|---|---|---|---|
| | Conc | | Sample | 7 | 14 | 21 | 28 |
| Product | (ppm) | Conc (ul) | # | Days | Days | Days | Days |
| DGH | 500 | 12 ul | 7 | 10 | 10 | 10 | 10 |
| | 1000 | 24 ul | 8 | 10 | 10 | 10 | 10 |
| | 1500 | 37 ul | 9 | 10 | 10 | 10 | 10 |
| | 2000 | 49 ul | 10 | 10 | 10 | 10 | 10 |
| OPP/DGH | 150 | 3.5 ul | 15 | 10 | 10 | 10 | 10 |
| | 250 | 6 ul | 16 | 10 | 10 | 10 | 10 |
| | 500 | 11 ul | 17 | 10 | 10 | 10 | 10 |
| | 750 | 18 ul | 18 | 10 | 10 | 10 | 10 |
| | 1000 | 22 ul | 19 | 10 | 10 | 10 | 10 |

### Mildew Resistance Testing of Franklin International Titebond Solvent Free Construction Adhesive

TABLE 5
Mildew Resistance Testing of Franklin International Titebond
Solvent Free Construction Adhesive
Test Method: ASTM D3273

| | | | | Mildew Results | | | |
|---|---|---|---|---|---|---|---|
| | Conc | | Sample | 7 | 14 | 21 | 28 |
| Product | (ppm) | Conc (ul) | # | Days | Days | Days | Days |
| DGH | 500 | 12 ul | 7 | 10 | 10 | 10 | 10 |
| | 1000 | 24 ul | 8 | 10 | 10 | 10 | 10 |
| | 1500 | 37 ul | 9 | 10 | 10 | 10 | 10 |
| | 2000 | 49 ul | 10 | 10 | 10 | 10 | 10 |
| OPP/DGH | 150 | 3.5 ul | 15 | 10 | 10 | 10 | 10 |
| | 250 | 6 ul | 16 | 10 | 10 | 10 | 10 |
| | 500 | 11 ul | 17 | 10 | 10 | 10 | 10 |
| | 750 | 18 ul | 18 | 10 | 10 | 10 | 10 |
| | 1000 | 22 ul | 19 | 10 | 10 | 10 | 10 |

### Mildew Resistance Testing of Franklin International Titebond Professional Drywall Adhesive

TABLE 6
Mildew Resistance Testing of Franklin International
Titebond Professional Drywall Adhesive
Test Method: ASTM D3273

| | | | | Mildew Results | | | |
|---|---|---|---|---|---|---|---|
| | Conc | | Sample | 7 | 14 | 21 | 28 |
| Product | (ppm) | Conc (ul) | # | Days | Days | Days | Days |
| DGH | 500 | 12 ul | 7 | 10 | 10 | 10 | 10 |
| | 1000 | 24 ul | 8 | 10 | 10 | 10 | 10 |
| | 1500 | 37 ul | 9 | 10 | 10 | 10 | 10 |
| | 2000 | 49 ul | 10 | 10 | 10 | 10 | 10 |
| OPP/DGH | 150 | 3.5 ul | 15 | 10 | 10 | 10 | 10 |
| | 250 | 6 ul | 16 | 10 | 10 | 10 | 10 |
| | 500 | 11 ul | 17 | 10 | 10 | 10 | 10 |
| | 750 | 18 ul | 18 | 10 | 10 | 10 | 10 |
| | 1000 | 22 ul | 19 | 10 | 10 | 10 | 10 |

TABLE 7
Mildew Resistance Testing of Franklin International
Titebond Solvent Free Subfloor Adhesive
Test Method: ASTM D3273

| | | | | Mildew Results | | | |
|---|---|---|---|---|---|---|---|
| | Conc | | Sample | 7 | 14 | 21 | 28 |
| Product | (ppm) | Conc (ul) | # | Days | Days | Days | Days |
| DGH | 500 | 12 ul | 7 | 7 | 7 | 0 | 0 |
| | 1000 | 24 ul | 8 | 7 | 7 | 0 | 0 |
| | 1500 | 37 ul | 9 | 7 | 7 | 0 | 0 |
| | 2000 | 49 ul | 10 | 10 | 10 | 10 | 10 |
| OPP/DGH | 150 | 3.5 ul | 15 | 10 | 9 | 0 | 0 |
| | 250 | 6 ul | 16 | 10 | 9 | 0 | 0 |
| | 500 | 11 ul | 17 | 10 | 9 | 0 | 0 |
| | 750 | 18 ul | 18 | 10 | 10 | 8 | 8 |
| | 1000 | 22 ul | 19 | 10 | 10 | 10 | 10 |

TABLE 8
Mildew Resistance Testing of Franklin International
Titebond Solvent Free Fast Grab FRP Adhesive
Test Method: ASTM D3273

| | | | | Mildew Results | | | |
|---|---|---|---|---|---|---|---|
| | Conc | | Sample | 7 | 14 | 21 | 28 |
| Product | (ppm) | Conc (ul) | # | Days | Days | Days | Days |
| DGH | 500 | 12 ul | 7 | 10 | 10 | 0 | 0 |
| | 1000 | 24 ul | 8 | 10 | 10 | 0 | 0 |
| | 1500 | 37 ul | 9 | 10 | 10 | 10 | 9 |
| | 2000 | 49 ul | 10 | 10 | 10 | 10 | 10 |
| OPP/DGH | 150 | 3.5 ul | 15 | 10 | 10 | 9 | 7 |
| | 250 | 6 ul | 16 | 10 | 10 | 9 | 7 |
| | 500 | 11 ul | 17 | 10 | 10 | 9 | 7 |
| | 750 | 18 ul | 18 | 10 | 10 | 10 | 10 |
| | 1000 | 22 ul | 19 | 10 | 10 | 10 | 10 |

### DEFINITIONS

“Coating”—an aqueous based formulation that is applied to a substrate and dries as a film. Examples of coatings include paint, caulks, dried adhesive, fire retardants, latex emulsions, pastes, polymers, sizing, and stains.

“The coating containing the antimicrobial mixture having superior antimicrobial effectiveness”—Performing better in a microbial growth testing either by having better results or by having the same effective results but requiring less of the individual components. Table 6 is an example of DGH having the same effective results but the combination of DGH/OPP requires less concentration. The testing can be in can preservative testing, Dry film fungicides/mildewcides, or any other microbial testing.

“Antimicrobials include any antimicrobial agents, biocides and preservatives. It can be any chemical that inhibit the growth of microorganisms. Antimicrobials are chosen depending on the end use product's function in the industrial sector. Antimicrobials will inhibit the growth of and or kill microorganisms in their applications. Leading to sterile conditions. Antimicrobial agents consist of commodity chemicals as well as specialty chemicals and can be classified as oxidizing or nonoxidizing. In these categories, the performance of the antimicrobials are described as either a sterilant (kills all types of life forms completely), sproicidal (kills spores), a disinfectant (kills all infectious bacteria), a cidal (kills all organisms) sanitizers (reduces the number of microorganisms to a safe level), an antiseptic (prevents infections) or a static (prevents growth of the microorganisms).

It is intended that all matter contained in the above description including the definitions shall be interpreted as illustrative and not as a limitation. Various changes could be made in the above description without departing from the scope of the invention as defined in the claims below.

We claim:

1. An antimicrobial synergistic mixture of orthophenylphenol or its sodium salt and dodecylguanidine hydrochloride wherein the mixture is determined to be antimicrobial synergistic by having a synergy index of less than 1 in a synthetic white water at pH from about 7-9.

2. An antimicrobial synergistic mixture of orthophenylphenol or its sodium salt and dodecylguanidine hydrochloride at a pH of about 7.0 in a ratio of dodecyl guanidine hydrochloride to orthophenylphenol or its sodium salt of about 4:1.

3. An antimicrobial synergistic mixture of orthophenylphenol or its sodium salt and dodecylguanidine hydrochloride at a pH from about 8.0-9.0 in a ratio of dodecylguanidine hydrochloride to orthophenylphenol or its sodium salt of about 16:1-65:1.

4. An antimicrobial synergistic mixture of orthophenylphenol or its sodium salt and dodecyl guanidinehydrochloride in a coating, wherein the mixture is determined to be antimicrobial synergistic by the coating containing the antimicrobial mixture having superior antimicrobial effectiveness when compared with the coating containing orthophenylphenol or its sodium salt without dodecylguanidine hydrochloride and the coating containing dodecylguanidine hydrochloride without orthophenylphenol or its sodium salt.

5. An antimicrobial synergistic mixture as recited in claim 4 wherein the coating is a latex emulsion.

6. An antimicrobial synergistic mixture as recited in claim 5 wherein the latex emulsion is paint.

7. An antimicrobial synergistic mixture as recited in claim 4 wherein the coating is a dried adhesive.

8. An antimicrobial synergistic mixture as recited in claim 7 wherein the coating is a caulk.
